(19) United States
(12) Patent Application Publication
(10) Pub. No.: US 2023/0167958 A9
(43) Pub. Date: Jun. 1, 2023

(54) LIGHT GUIDE STRUCTURE

(71) Applicant: TAN DE TECH CO., LTD., DOULIU CITY (TW)

(72) Inventors: CHAO PAI LEE, DOULIU CITY (TW); CHENG CHIH LAI, DOULIU CITY (TW); CHUNG CHIANG PAN, DOULIU CITY (TW)

(21) Appl. No.: 17/748,416

(22) Filed: May 19, 2022

Related U.S. Application Data
(63) Continuation-in-part of application No. 17/164,508, filed on Feb. 1, 2021, now Pat. No. 11,549,654.

(30) Foreign Application Priority Data
Nov. 17, 2020 (TW) 109140136

(51) Int. Cl. F21S 41/24; F21V 8/00

(52) U.S. Cl. CPC F21S 41/24; G02B 6/0036; F21Y 2115/10

(57) ABSTRACT

A light guide structure with jagged protrusions is configured in a lighting device of a mobile vehicle. The light guide structure comprises a light injecting surface and a light emitting surface. The light injecting surface comprises a middle section and two side sections deployed respectively at opposite ends of the middle section. At least a portion of the side sections has a light guiding area. A light source module forms an irradiation area by the light guide structure, the microstructure of the light guiding area is configured to enable the light from the light guide to pass through the light injecting surface generating refraction, diffusion, or scattering, so as to reduce the generation of stray light, and improve the clarity of the beam contour.

### CROSS REFERENCE TO RELATED APPLICATIONS

This application is a Continuation-in-Part of co-pending application Ser. No. 17/164,508, filed on 1 Feb. 2021, for which priority is claimed under 35 U.S.C. § 120; and this application claims priority of Application No. 109140136 filed in Taiwan on 17 Nov. 2020_under 35 U.S.C. § 119, the entire contents of all of which are hereby incorporated by reference.

### BACKGROUND

### Technical Field

The present disclosure is directed to a light guide structure for a headlight configured to adjust beam contour and partial luminance of low beam lights.

### Related Art

LED headlight modules adjust beam contour and luminance distribution by light guides, lens, etc., in compliance with government regulations or to improve glare as a result of direct light.

### SUMMARY

The present disclosure is directed to a light guide structure configured in a lighting device of a mobile vehicle. The light guide structure comprises a light injecting surface and a light emitting surface. The light emitting surface comprises a middle section and two side sections deployed respectively at opposite ends of the middle section. At least a portion of the side sections forms a light guiding area.

In some embodiments, the guiding area has a plurality of light guiding microstructures arrayed in a matrix.

In some embodiments, the guiding area has a plurality of jagged protrusions, an extending direction of the jagged protrusions is vertical to a light injecting direction of the lighting device.

In some embodiments, the jagged protrusions provide with sloped light injecting surface.

### BRIEF DESCRIPTION OF THE DRAWINGS

FIG. 1 is an external view of an embodiment showing the light guide structure with jagged protrusions, and a partial enlarged view of the microstructure of the light emitting surface thereof.

FIG. 2 is another partial enlarged view showing the microstructure of the light emitting surface of FIG. 1.

FIG. 3 is a cross-sectional view showing the microstructure of the light emitting surface of FIG. 1.

FIG. 4 is a schematic diagram showing the light guide of the microstructure of the light emitting surface of FIG. 1.

FIG. 5 is a front view showing another embodiment of the light guide structure with jagged protrusions.

FIG. 6 is a partial enlarged view showing the microstructure of the light emitting surface of FIG. 5.

FIG. 7 is a schematic diagram showing the light guide of the microstructure of the light emitting surface of FIG. 5.

FIG. 8 is a schematic diagram showing another embodiment of the light guide structure with jagged protrusions.

FIG. 9 is a partial enlarged view showing the microstructure of the light emitting surface of FIG. 8.

FIG. 10 is a schematic diagram showing another embodiment of the light guide structure with jagged protrusions.

FIG. 11 is a side view of the light guide structure of FIG. 10.

FIG. 12 is a schematic diagram showing an embodiment of a headlight structure and a partial enlarged view of the microstructure of the light emitting surface of the headlight lens.

FIG. 13 is a side view showing a headlight structure.

FIGS. 14 and 15 are diagrams showing the results of the irradiation area deploying the light guide structure with jagged protrusions of FIG. 1.

FIG. 16 is a diagram showing the result of the irradiation area deploying the light guide structure with jagged protrusions of FIG. 5.

FIG. 17 is a diagram showing the result of the irradiation area deploying the headlight structure of FIG. 12.

FIG. 18 is an embodiment showing the light injecting surface of the light guide structure.

FIG. 19 is a diagram showing the result of the light injection deploying the lighting guide structure of FIG. 18.

FIG. 20 is another embodiment showing the light injecting surface of the light guide structure.

FIG. 21 is a diagram showing the result of the irradiation deploying the lighting guide structure of FIG. 20.

### DETAILED DESCRIPTION

The following description is in accordance with common understanding of those skilled in the art. The light emitting direction (positive direction of X-axis) of headlights is referred as front. An irradiation area is referred to an illuminating area formed after the light source is reflected, refracted, or diffused by the light guide. The beam contour is referred to a light/dark border of the above-mentioned irradiation area.

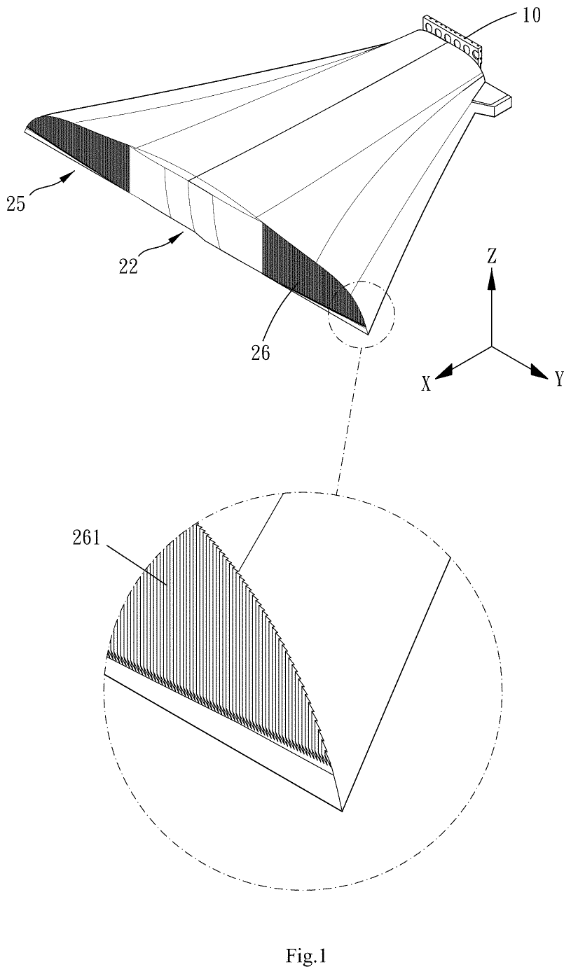

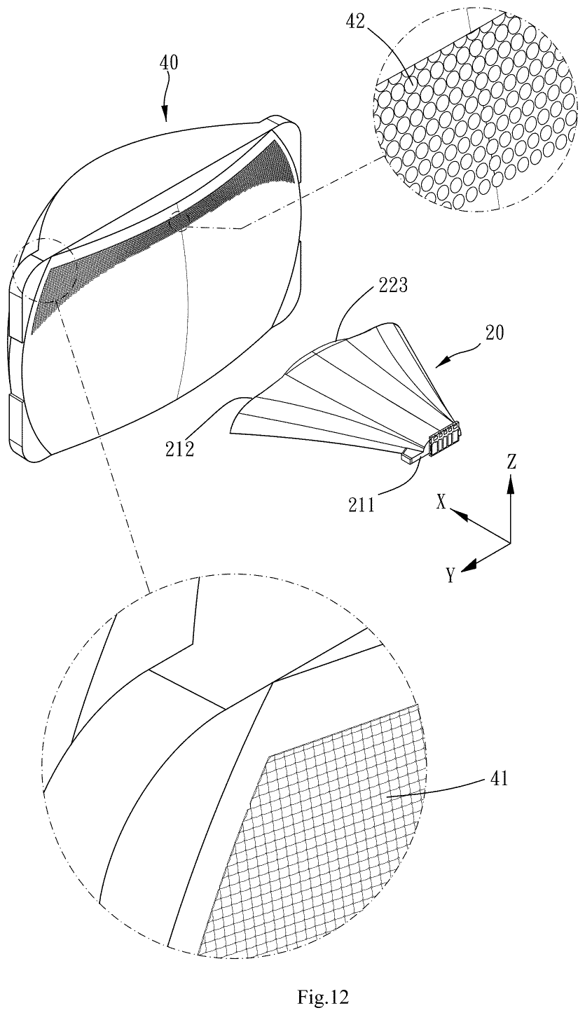

Please refer to FIG. 1-FIG. 4, the instant disclosure provides an embodiment of a light guide structure with jagged protrusions configured in a lighting device of a mobile vehicle. The light guide structure with jagged protrusions comprises a light injecting surface 211 (as shown in FIG. 12) provided with a light source module 10 and a light emitting surface 212 (as shown in FIG. 12) facing a light emitting direction. A contour of the light emitting surface 212 of the light guide structure is used to define a beam contour projected by the light source module 10. Taking a view shown in FIG. 5 as an example, the contour of the light emitting surface 212 is roughly divided into a cutoff contour formed by two bevels and an upper contour (The contour of reference sign 22) having an arc contour. The upper contour and a lower contour are overlapped at both ends of the light emitting surface 212 forming the cutoff contour. In addition, the light emitting surface 212 being elongated has a middle section 22 and two side sections 25 configured at both sides of the middle section 22.

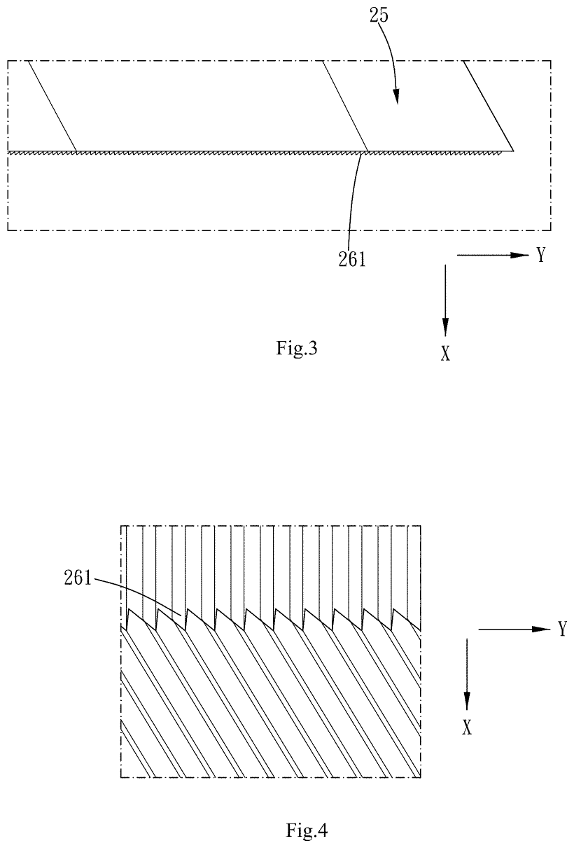

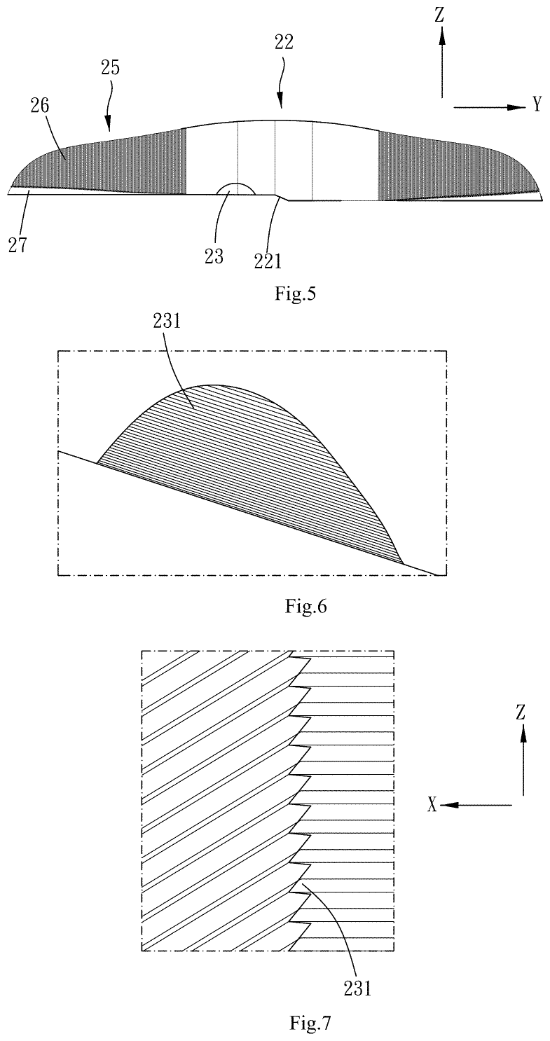

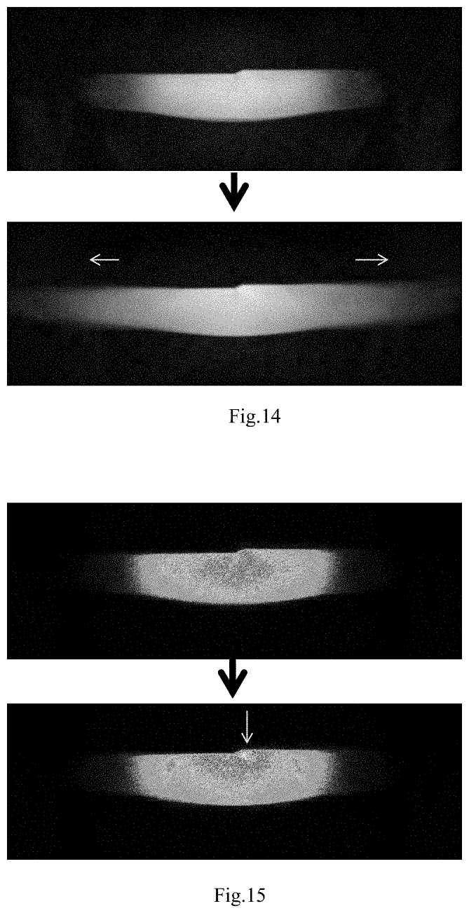

Please refer to FIG. 1-FIG. 4, the instant disclosure provides an embodiment, the side sections 25 have a plurality of jagged protrusions 261 forming a light guiding area 26, the cross-section of each jagged protrusion 261 being triangular (as show in FIG. 3 and FIG. 4), the extending direction (z-direction) of the jagged protrusions 261 being vertical to the light emitting direction (x-direction), the jagged protrusions 261 having an inclined light emitting surface, a plurality of the jagged protrusions 261 being arrayed along the light emitting surface 212 forming a continuous and inclined V-shaped grooves (as shown in FIG. 4), which enables the light from the light guide to emit to outside, thereby enlarging the width of the beam contour. Please also refer to FIG. 14, the light from the light source module 10 passes through the light guide structure with jagged protrusions forming the irradiation area, the jagged protrusions 261 of the light guiding area 26 extending the width of the irradiation area on both sides. Further, each of the side sections 25 is average ⅓ of the length in a longitudinal direction of the light emitting surface 212, the beam contour being enlarged evenly in a horizontal direction.

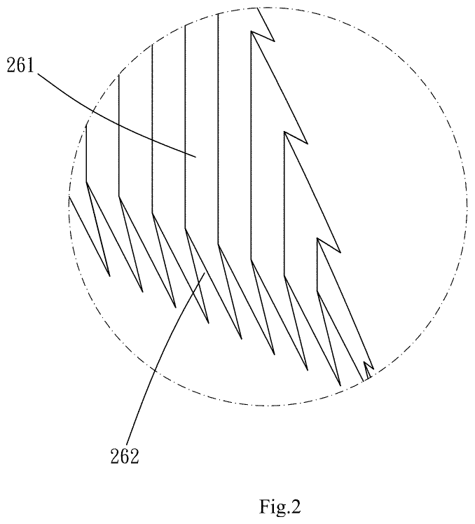

Please refer to FIG. 5. the instant disclosure provides an embodiment, the side sections 25 have a smooth area 27 neighboring the lower contour and at least one light guiding area 26 neighboring the upper contour. Please also refer to FIG. 2, the jagged protrusions 261 has a cutting angle 262 tiled from the top to bottom (lower contour) outwardly forming a cutting face, the cutting face formed by the cutting angle 262 of the jagged protrusions 261 being continuous with a side face of the smooth area 27 to adjust the light/dark border generated by the lower contour or adjust into corresponding beam contours.

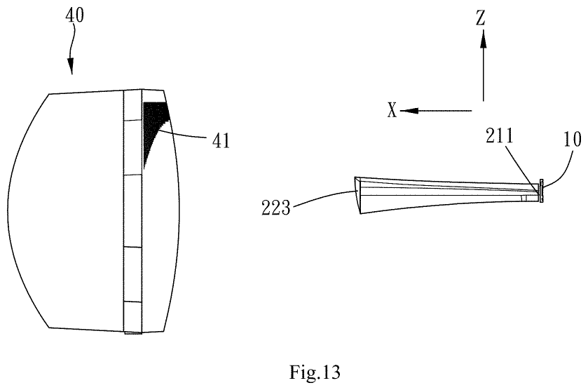

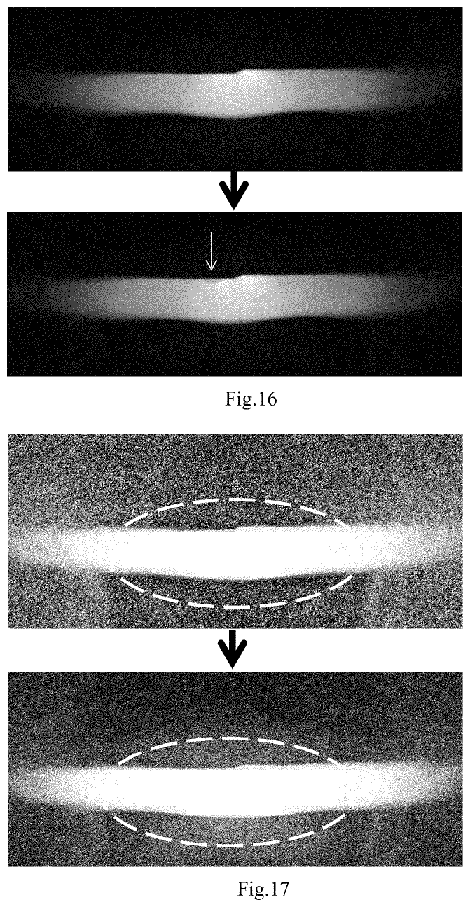

Please refer to FIG. 1 and FIG. 13, the middle section 22 of the light emitting surface 212 of the light guide structure with jagged protrusions protrudes toward the light emitting direction forming a convex surface 223 generating a beam contour shown by an arrow in the lower section of FIG. 15, the middle section 22 corresponding to the irradiation area, partial luminance of the irradiation area being increased by a spotlight (the color is white).

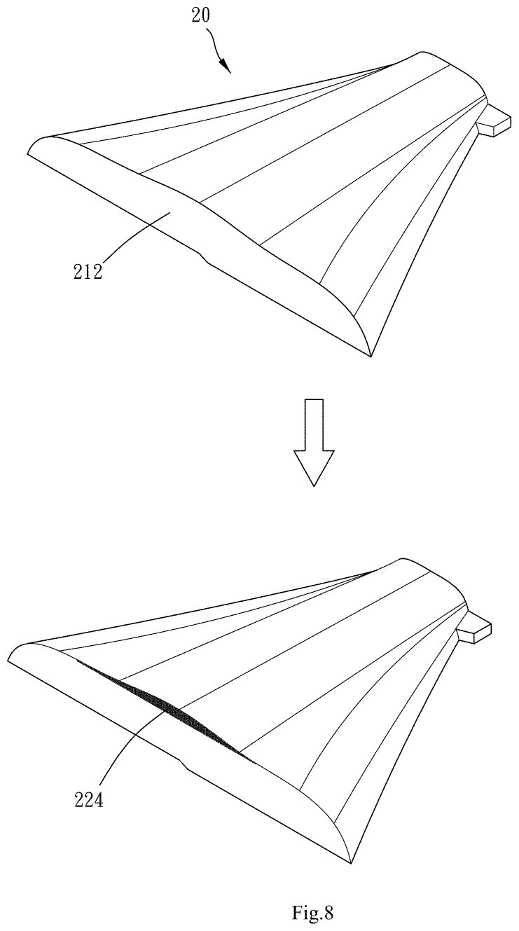

Please refer to FIG. 5 to FIG. 7, the instant disclosure provides an embodiment, the light emitting surface 212 having the middle section 22 provided with a light guiding area 23 neighboring the cutoff contour 221, the light guiding area 23 having a plurality of dentate protrusions 231 provided with sloped light emitting surface being deployed to change the angle of light instead of directly emitting to the front (x-direction), the area of the beam contour being partially astigmatic, generating a notch shown by an arrow in the lower section of FIG. 16. The light guiding area 23 reduces luminance (generated by the convex surface 223), and prevents the luminance of the irradiation area of the cutoff contour 221 from being too high, which may affect the vision of the oncoming driver. Specifically, the cross section of the dentate protrusions 231 of the light guiding area 23 is identical (being triangular) to or different from the jagged protrusions 261, the extending direction of the dentate protrusions 231 is identical to or intersects with the extending direction of the jagged protrusions 261.

In addition, the microstructure of the light guiding area 23 is configured to enable the light from the light guide to emit through the light emitting surface 212 generating refraction, diffusion, or scattering, for example, the microstructure of the light guiding area 23 is a plurality of dot plane contours, a plurality of round convex points, a plurality of polygonal plane contours, or a plurality of polygonal convex points, or a matrix structure similar to the light guiding microstructure 41, 42 described below having a similar effect.

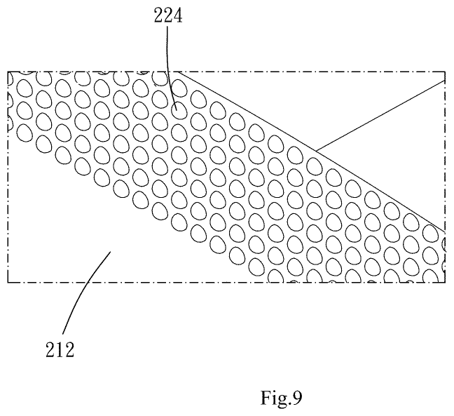

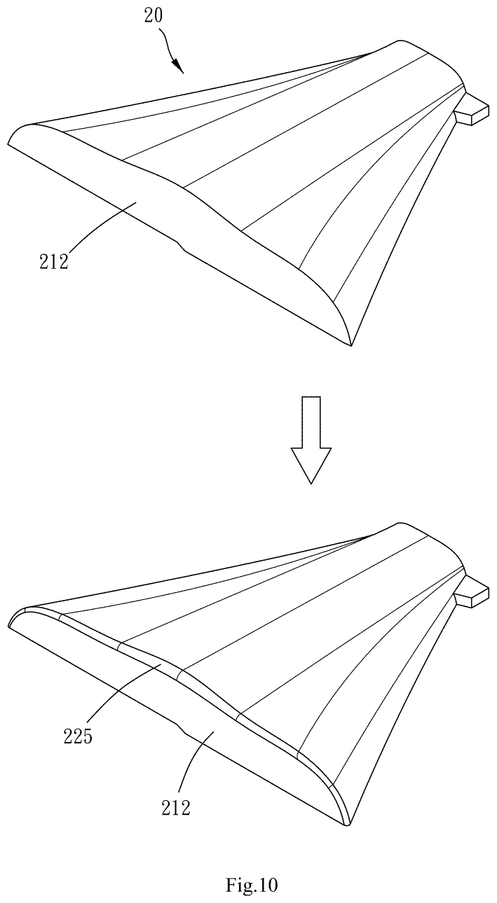

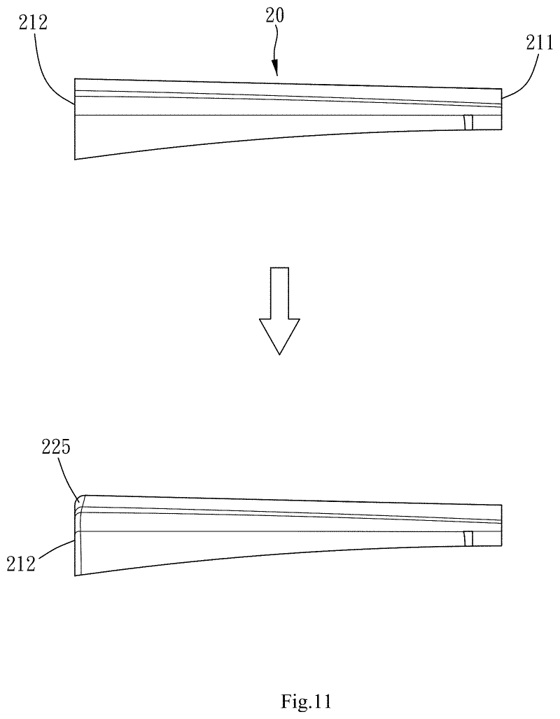

Please refer to FIG. 8 and FIG. 9, the instant disclosure provides an embodiment showing the light emitting surface of the light guide structure with jagged protrusions, the light emitting surface 212 of the light guide structure with jagged protrusions being roughly planar (for example, shown in the upper section of FIG. 11), the light emitting surface 212 forming another elongated light guiding area arranged in the middle section of an arc contour of the upper contour of the light emitting surface 212. The light guiding microstructure 224 of the light guiding area comprises a plurality of round convex points forming a matrix, generating the beam contour shown in the lower section of FIG. 17, improving the Blue field entoptic phenomenon of the beam contour.

The formation of the Blue field entoptic phenomenon is due to the use of white light LEDs as a light source. This type of LED is usually a mixture of LED blue light and phosphor yellow light. Because blue light has characteristics of short wavelength and large refraction angle, the edge of the beam contour is prone to generate blue lines. When driving, the blue lines generated by the beam contour easily affects the vision of the oncoming driver and generates afterimages. Therefore, improving the Blue field entoptic phenomenon ensures driving safety.

Please refer to FIG. 10 and FIG. 11, the instant disclosure provides an embodiment showing the light emitting surface of the light guide structure with jagged protrusions, the planar light emitting surface 212 being configured to improve Blue field entoptic phenomenon, the upper contour of the light emitting surface 212 of the light guide structure with jagged protrusions being provided with a round angle formed along the edge of the arc contour, an elongated light guiding contour 225 being formed on the upper contour of the light guide structure with jagged protrusions. The light guide structure enables the light to emit from the upper contour generating refraction, diffusion, or scattering, generating the beam contour shown in the lower section of FIG. 17. Optionally, at least a part of the edge of the arc contour of the light emitting surface is configured with a round angle, the corresponding position provided with the above-mentioned light guiding contour 225, generating a similar effect.

Please refer to FIG. 13 and FIG. 14, the instant disclosure provides an embodiment showing a headlight structure, the light source module 10 comprising a light guide 20 and a lenticular lens 40 sequentially configured in the light emitting direction, the light guide 20 being formed into the aforementioned light guide structure, the light emitting surface 212 of the light guide 20 defining the beam contour and the irradiation area, the light emitting surface 212 having at least a plurality of the jagged protrusions 261 configured on the side sections 25 of the light emitting surface 212, and the extending direction of the jagged protrusions 261 intersects with light emitting direction.

In the light emitting direction, the lenticular lens 40 roughly forms a rectangular contour, the lenticular lens 40 having a plurality of light guiding microstructures 41, 42 arrayed in a matrix, the light guiding microstructures being configured along at least the edge of the corresponding beam contour in the light emitting direction. The edge refers to the light/dark border near the irradiation area, but not limited to this, the light guiding microstructures capable of adjusting the beam contour on any position of the lenticular lens 40 respectively, hereby generating the beam contour shown in the lower section of FIG. 17 to improve Blue field entoptic phenomenon.

The instant disclosure provides an embodiment, the light guiding microstructures 41, 42 form a plurality of light guiding areas on the light injecting surface of the lenticular lens 40. When approaching the short side of the lenticular lens 40 (that is, corresponding to the beam contour of the side sections 25 of the modified light guide 20), the light guiding microstructure 41 is a square matrix. When approaching the middle section of the lenticular lens 40 (that is, corresponding to the beam contour of the middle section 22 of the light guide 20), the light guiding microstructure 42 is a circular matrix. Other parts of the light guiding microstructures are gradually changed from a square to a circle from the short side to the middle section of the lenticular lens 40, improving the damage to the vision of the oncoming driver caused by the Blue field entoptic phenomenon.

In some embodiments, the lens 40 is any lens that generates a spotlight effect, such as a plano-convex lens.

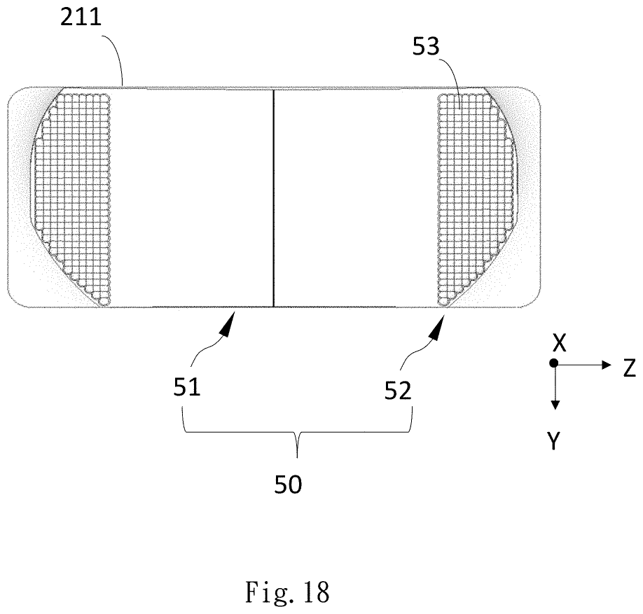

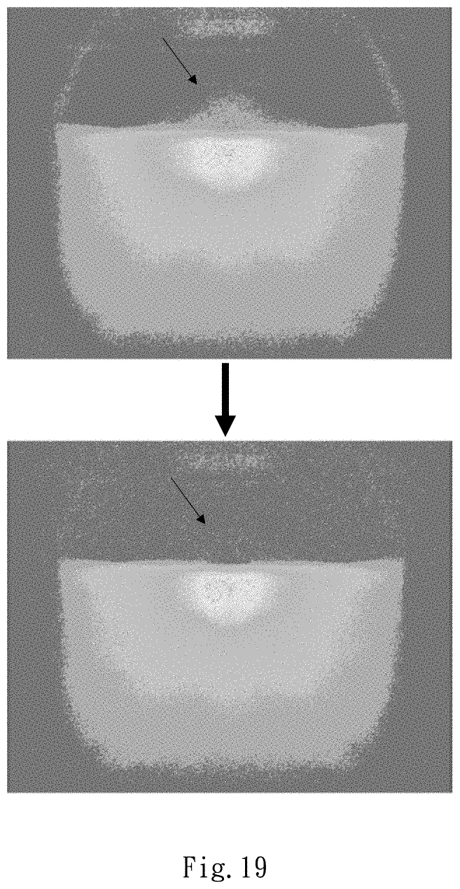

Please refer to FIG. 18, the instant disclosure provides an embodiment, the light injecting surface 50 comprises a middle section 51 and two side sections 52 deployed respectively at opposite ends of the middle section 51, and at least a portion of the side section 52 providing with a light guiding area 53. The microstructure of the light guiding area 53 has a plurality of round convex points forming a matrix, the microstructure of the light guiding area 53 configured to enable the light from the light guide to pass through the light injecting surface 50 generating refraction, diffusion, or scattering, so as to reduce the generation of stray light and improve the clarity of the beam contour. In other embodiment, the microstructure of the light guiding area 53 is a plurality of dot plane contours, a plurality of polygonal plane contours, or a plurality of polygonal convex points. Please also refer to FIG. 19, the light from the light source module 10 passes through the light injecting surface 50 of the light guide structure forming the injection area, the round convex points of light guiding area 53 can reduce the generation of stray light (as indicated by the arrow in FIG. 19), and improve the clarity of the beam contour.

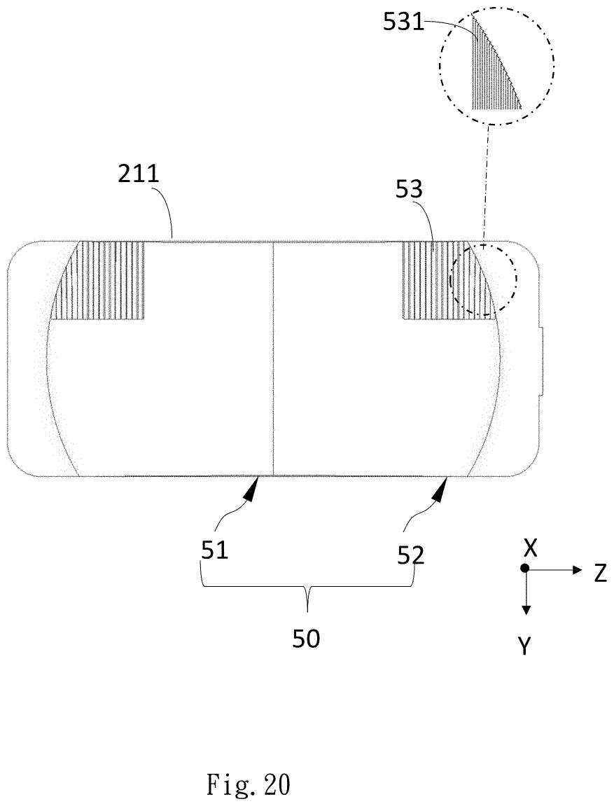

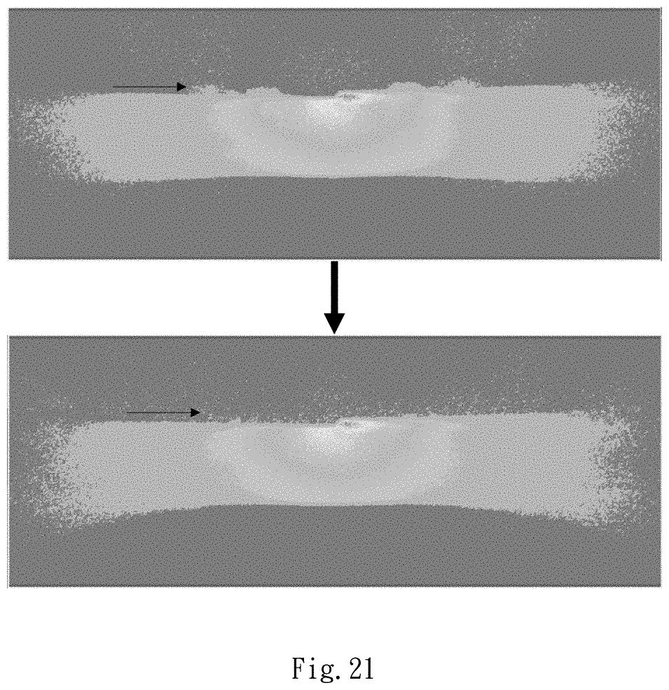

Please refer to FIG. 20, the instant disclosure provides another embodiment, a plurality of jagged protrusions 531 arranged in the light guiding area 53, the light guiding area 53 configured on the side section 52 of the light injecting surface 50 and adjacent to the edge of the upper contour, and the light guiding area 53 occupying about ⅓ of the area of the side section 52. The extending direction of the jagged protrusions 531 is vertical to the light injecting direction (x-direction), the jagged protrusions 531 having an inclined light injecting surface, a plurality of the jagged protrusions 531 being arrayed along the light injecting surface 50 forming a continuous and inclined V-shaped grooves. Please also refer to FIG. 21, the light from the light source module 10 passes through the light guide structure with jagged protrusions 531 forming the irradiation area, the jagged protrusions 531 of the light guiding area 53 can reduce the generation of stray light (as indicated by the arrow in FIG. 21), and improve the clarity of the beam contour.

What is claimed is:

1. A light guide structure configured in a lighting device of a mobile vehicle, comprising:
a light injecting surface and a light emitting surface;
wherein the light injecting surface comprises a middle section and two side sections deployed respectively at opposite ends of the middle section;
wherein at least a portion of the side sections forms a light guiding area.

2. The light guide structure of claim 1, wherein the guiding area has a plurality of light guiding microstructures arrayed in a matrix.

3. The light guide structure of claim 1, wherein the guiding area has a plurality of jagged protrusions.

4. The light guide structure of claim 3, wherein an extending direction of the jagged protrusions is vertical to a light injecting direction of the lighting device.

5. The light guide structure of claim 3, wherein the jagged protrusions provide with sloped light injecting surface.
